(19) United States
(12) Patent Application Publication
(10) Pub. No.: US 2019/0319923 A1
(43) Pub. Date: Oct. 17, 2019

(54) NETWORK DATA CONTROL METHOD, SYSTEM AND SECURITY PROTECTION DEVICE

(71) Applicant: Alibaba Group Holding Limited, Georgetown (KY)

(72) Inventor: Yifan TU, Hangzhou (CN)

(21) Appl. No.: 16/385,321

(22) Filed: Apr. 16, 2019

(30) Foreign Application Priority Data
Apr. 16, 2018 (CN) 201810338692.9

(51) Int. Cl. H04L 29/06

(52) U.S. Cl. CPC H04L 63/0227; H04L 63/0218

(57) ABSTRACT

A network data control method, system and security protection device, the method comprising the steps of: receiving flow characteristic information reported by a firewall; analyzing the flow characteristic information or the network behavior information determined by the flow characteristic information to obtain an analysis result; and on the basis of the analysis result, determining the control instruction to be sent to the firewall, wherein the control instruction is used to control network data passing through the firewall. Advantageously, the present invention addresses a prior art problem in firewall poor performance in protecting network data.

### PRIORITY CLAIM

This patent application claims priority to China Patent Application No. 201810338692.9 filed Apr. 16, 2018, herein incorporated by reference in its entirety.

### TECHNICAL FIELD

The present invention relates to a computer network field, specifically to network data control method, system and security protection device.

### BACKGROUND

A firewall is a technical measure to protect the security of a computer network, which blocks attack to the network from the outside by isolating the intranet from the extranet by means of building a corresponding network communication monitoring system at the network boundary. FIG. 1 is an illustration of an optional protection structure of the firewall on the basis of prior arts, as shown in FIG. 1, when the carrier data at the Internet Service Provider (ISP) side enters a router, the data will be distributed inside the firewall group through the load-balancing strategy of the router. The firewall checks and the filters the data passing it snowed before forwarding the data to the exchanger to be forwarded to the final service server.

Currently, the existing firewall protection structure has the following two issues: 1. The load-balancing strategy of the router may interfere with the running of the firewall. Because the load balancing strategy of the router is relatively fixed, if the load balancing is performed according to the IP layer, the IP hash attack can easily cause certain firewall equipment to become a hotspot, which influences the processing result and even leading to firewall breakdown; if the load balancing is performed according to TCP layer, then the IP layer-based strategies will be multiplied according to the number of the firewall groups increased, and a single firewall equipment is unable to see the whole picture of a particular IP data, thus affecting the processing. 2. In the existing equipment, most of the firewalls do not have the capacity for multi node scaling out. In a general application scenario, two firewall devices are often used as a unit for load-balancing, which is incapable of scaling out freely. Therefore, the upper limit of the bandwidth capacity of the firewall operation is liable to become the bottleneck of the service processing.

For the above problem, where the existing firewall modes have poor protection performance for the network data, no effective solution has been proposed at present.

### SUMMARY

Provided in embodiments of the present invention are a network data control method, system and security protection device, to at least solve the technical problem in the existing firewall modes in terms of their poor performance in protecting network data.

According to one aspect of the present invention, a control method for network data is provided, comprising: receiving the flow characteristic information reported by the firewall; analyzing the flow characteristic information or the network behavior information determined by the flow characteristic information to obtain the analysis result; on the basis of the analysis result, determining the control instruction to be sent down to the firewall, wherein, the control instruction is used to control the network data passing through the firewall. In some embodiments, “analyzing the flow characteristic information” can cover “analyzing the network behavior information determined by said flow characteristic information”, since the “network behavior” is determined by the “flow characteristic information”.

According to another aspect of the present invention, a control system for network data is also provided, comprising: a firewall, located in between the first equipment and the second equipment, for extracting the flow characteristic information of the network data of communication between the first equipment and the second equipment; a firewall analysis device, communicating with the firewall, for receiving the flow characteristic information reported by the firewall; analyzing the flow characteristic information and/or the network behavior information determined by the flow characteristic information to obtain the analysis result; and on the basis of the analysis result, determining the control instruction to be sent down to the firewall, wherein, the control instruction is used to control the network data passing through the firewall.

According to another aspect of the present invention, a security protection device is also provided, comprising: a firewall, for acquiring the network data and extracting the flow characteristic information of the network data; a firewall analysis device, communicating with the firewall, for receiving the flow characteristic information reported by the firewall; analyzing the flow characteristic information and/or the network behavior information determined by the flow characteristic information to obtain the analysis result; and on the basis of the analysis result, determining the control instruction to be sent down to the firewall, wherein, the control instruction is used to control the network data passing through the firewall.

According to another aspect of the present invention, a storage medium is also provided, wherein the storage medium comprises the program stored wherein, when the program is running, the equipment where the storage medium is located is controlled to perform the following instruction of processing steps: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

According to another aspect of the present invention, a processor is also provided to run the program, wherein, when the program is running, instructions of the following steps are implemented: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

According to another aspect of the present invention, a control system for network data is also provided, comprising: a processor; and a storage device, connected to the processor, to provide the processor with instruction to process the following processing steps: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

According to another aspect of the present invention, a data processing method is also provided, comprising: receiving the flow characteristic information from the first network device; analyzing the flow characteristic information and/or the network behavior information determined by the flow characteristic information to obtain the analysis result; on the basis of the analysis result, determining the control instruction sent to the first network device, wherein, the control instruction is used to control the network data passing through the first network device.

In embodiments of the present invention, a distributed deployment of firewall is used, by receiving flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall, the objective has been achieved in terms of limiting network data by distributing them in multiple firewalls to break through the bandwidth limitation as well as performing complex analysis to the network data to overcome network attack, so as to realize the technical effects of improving the network protection performance, and have solved the technical problem in the existing firewall modes in terms of their poor performance in protecting network data.

### BRIEF DESCRIPTION OF DRAWINGS

The drawings herein provide further understanding of the present invention, constitute a part of the present invention and are illustrative of embodiments of the present invention and do not constitute an inappropriate limitation of the present invention.

FIG. 1 is an illustration of a prior art protection structure of a firewall.

FIG. 2 is an illustration of a system for controlling network data in accordance with the present invention.

FIG. 3 is an illustration of a system structure for controlling network data consisting of multiple firewalls that uses distributed deployment, in accordance with the present invention.

FIG. 4 is an illustration of a system for controlling network data in accordance with the present invention.

FIG. 5 is an illustration of a structure for a firewall analysis device in accordance with the present invention.

FIG. 6 is an illustration of a firewall structure in accordance with the present invention.

FIG. 7 is a flowchart of a network data control method in accordance with the present invention.

FIG. 8 is an illustration of a protection structure of the firewall in accordance with the present invention.

FIG. 9 is a flowchart of a network data control method in accordance with the present invention.

FIG. 10 is a flowchart of a network data control method in accordance with the present invention.

FIG. 11 is a flowchart of a network data control method in accordance with the present invention.

FIG. 12 is a flowchart of a network data control method in accordance with the present invention.

FIG. 13 is an illustration of a network data control device in accordance with the present invention.

FIG. 14 is an illustration of a security protection device in accordance with the present invention.

FIG. 15 is a frame chart of the structure of hardware of computer terminal in accordance with the present invention.

FIG. 16 is a flowchart of a data processing method in accordance with the present invention.

### DETAILED DESCRIPTION

### Embodiments

In order for a person skilled in the art to better understand the present invention, embodiments of the present invention are described clearly and thoroughly with reference to drawings of the present invention. Embodiments described herein are only some embodiments of the present invention, as not all embodiments are described. On the basis of the embodiments of the present invention described herein, all the equivalent embodiments obtained by a person skilled in the art without involving an inventive skill, shall fall into the protection scope of the present application.

Terms such as “the first”, “the second” etc. in the description, claims and the above-mentioned drawings of the present application are used to differentiate similar objects, and not necessarily used to describe specific order or sequence. It shall be understood that the data used in this way can be exchanged in proper situation, so that the embodiments of the present invention described herein can be implemented in an order besides those described in the drawings or description herein. In addition, the terms “comprise” and “have” and any variations thereof are intended to cover a nonexclusive inclusion, for example, the process, method, system, product or device that include a series of steps or units are not limited to those steps or units that have been clearly listed, but rather may include other steps or units that are not clearly listed or are not intrinsic to this process, method, product or device.

Names or terms that occur in the description of embodiments of the present invention are applicable to the following description:

A firewall can be a protective barrier formed by a combination of software and hardware devices, formed at the boundary between the intranet and the extranet or between a private network and a public network; it can also be software or hardware between a computer and the network it connects with, where all the data packets flow in and out of the computer are required to pass through the firewall so as to protect the intranet, the private network and the computer from being attacked by an illegal user. A flow firewall is software or hardware that is deployed in a distributed manner to inspect, filter and protect the network data in a distributed way. It can be in the form of software (for example, the software provided by various proxy servers), hardware (for example, dedicated firewall device) or firmware (for example, firmware that is embedded in a router for data packet filtering).

### Embodiment 1

According to the embodiment of the present invention, provided is a network data control system, which can be applied to the network security protection between the intranet and the extranet, between a private network and a public network, and between a computer and the network it connects with.

As the Internet is bringing people convenience for both life and work, people are paying more and more attention on information security due to the openness of the Internet. The firewall, as an isolation technique, can inspect, filter and the constraint the network communication data between two networks (including but not limited to two intranets, and an intranet and an extranet), or between a terminal device (any Internet enabled device, including but not limited to a cell phone, a laptop, a computer or a tablet etc.) and the network, so as to prevent unauthorized access, thus to ensure the security for the intranet or for the terminal device.

With the development of services of various bandwidth (for example, network video, IPTV, and P2P service), the traditional single firewall has become the bottleneck that limits the increase of the network bandwidth and greatly restricting the actual application of the network in the meanwhile reducing the network performance and the expandability. The single firewall not only has the problem of single-point access and the network performance being limited by the firewall bandwidth, it also has the problem of single-point of failure; currently, most firewall manufacturers use a manner of dual machine hot standby to solve the single-point of failure issue. In a dual machine hot standby system, a firewall node is in an active working status, becoming the active firewall, and the other firewall node is used as a standby, which is in a hot waiting and monitoring status. It shows that the manner of dual machine hot standby does not solve the problem of single point access.

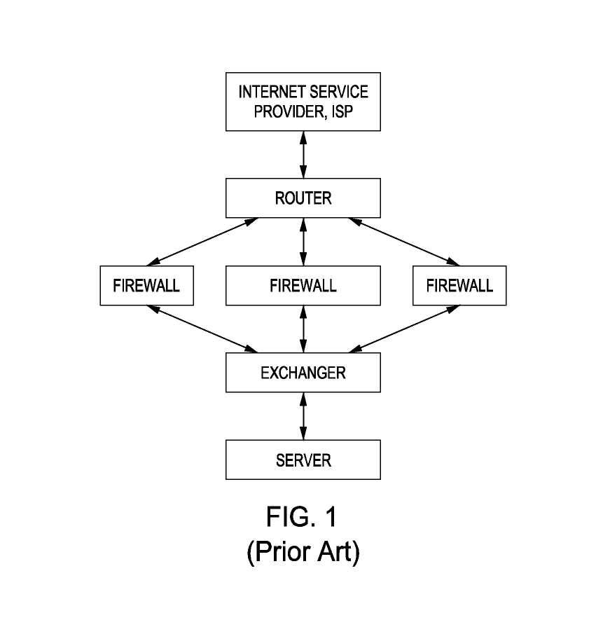

Further, in order to solve the single-point access problem, in prior arts, multiple firewalls are connected in parallel to form a firewall group where multiple firewalls thereof work together to realize the function of a traditional single firewall to achieve a better performance. For example, the firewall structure as shown in FIG. 1, after the network data enters the router, distributes data to multiple firewalls by means of load-balancing by the router, allowing each firewall to only inspect and filter the data that flow through itself.

FIG. 1 is a prior art single firewall that can only see the network data that flow through itself, and cannot see the whole picture of the entire IP data, thus being susceptible to an IP-based network attack. In addition, due to the lack of expandability in the node level, the firewall is unable to expand in any level of nodes; in prior arts, two firewalls are usually used for load-balancing, which still has the issue of the limitation in bandwidth capacity.

The inventor found through research that if using distributed deployment, which uses multiple firewalls that are deployed in a distributed manner to realize the function of a traditional single firewall, not only the problem of the limitation of bandwidth capacity can be solved, but also with the distributed framework, the network data monitored by multiple firewalls can be analyzed in an aggregated manner to overcome the IP-based network attack. Hence, the embodiment of the present invention provides a flow based firewall system with distributed deployment to realize the control of the network data.

As can be appreciated, embodiments of the present invention provides a network data control system that is applicable to any type of firewall based network security system, either be used as a hardware, or a software, and optionally as a firmware to be built in other devices (for example, the router).

In addition, and as can be appreciate, embodiments of the present invention provides a network data control system that can be used for protection in the network layer, or for the protection in the application layer, wherein, in the case of the protection in a network layer, the information included in the monitored network data includes but not limited to the source address, the target address, the application, the protocol and the interface for each data packet, so that the operation, such as forwarding, discarding or blocking, to be implemented on the network data content can be determined on the basis of this information; in the case of the protection in the application layer, the network data to be monitored may also include the specific contents of the network data so that relatively complicated access control can be realized on the basis of this information. It can be easily noticed that the protection in the application layer is more secure than the protection in the network layer, by the implementation efficiency of which is lower than that in the protection in the network layer.

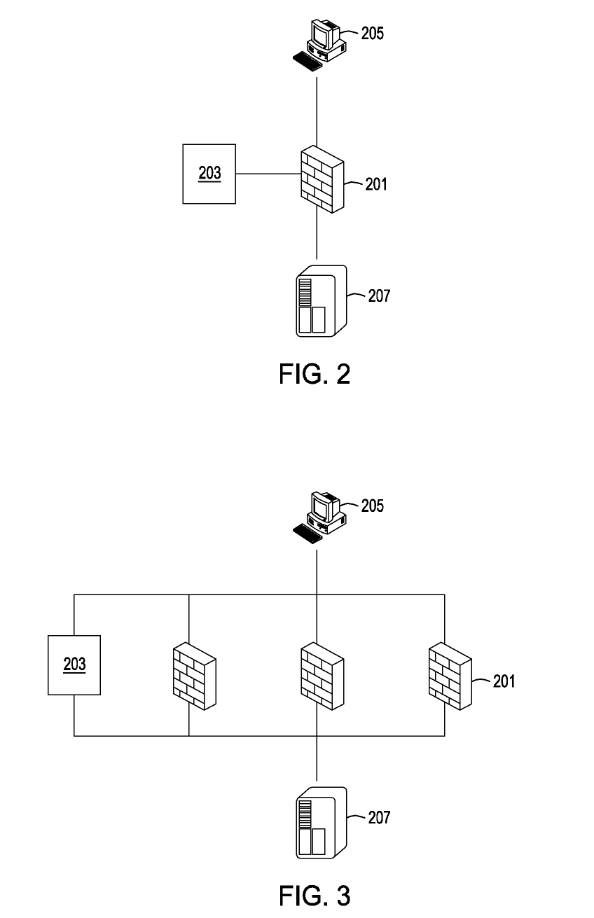

FIG. 2 is an illustration of an embodiment of the present system for controlling network data wherein the firewall 201, located between the first device 205 and the second device 207, is used to extract the flow characteristic information of the network data communicated between the first device and the second device.

Optionally, the first device and the second device may be a relative concept, where the first device and the second device may be two devices both of which have no access to the network, or one device have access to network and the other one have no access to network, or both devices have access to network. In the case that the first device and the second device are two devices that have access to network, the first device and the second device may be two devices that are located in different local area network, or it can be one is a device located in a local area network, the other one is in an Internet; as an optional embodiment, either device of the first device and the second device can be a device that is in an intranet or a private network, and the other one is in an extranet or a public network.

It is to be noted that because the data communicated in between the first device and the second device will all flow through a firewall, so the firewall can acquire the network data communicated between the first device and the second device and extract the flow characteristic information of the network data source to determine, on the basis of the extracted flow characteristic information, whether to allow the network data to pass through the firewall.

The firewall analysis device 203 communicates with the firewall 201 for receiving the flow characteristic information reported by the firewall; analyzing the flow characteristic information or the network behavior information determined by the flow characteristic information to obtain the analysis result; and on the basis of the analysis result, determining the control instruction to be sent down to the firewall, wherein, the control instruction is used to control the network data passing through the firewall. In some ways, analyzing the flow characteristic information can cover “analyzing the network behavior information determined by said flow characteristic information”, since the “network behavior” is determined by the “flow characteristic information”.

Optionally, the firewall analysis device and the firewall can locate on the same device or in different devices; it is easily noticed that both the firewall analysis device and the firewall may exist in the format of a software or a hardware; therefore, the functions realized by the firewall analysis device and the firewall can also be realized in the format of a software or a hardware.

It is to be noted that the firewall may be a single one or multiple ones, that is, the firewall analysis device may communicate with a single firewall, or communicate with multiple firewalls; when the firewall device communicate with multiple firewalls, the firewall analysis device can receive the flow characteristic information reported by the multiple firewalls, and perform aggregated analysis (including but not limited to performing aggregated analysis on the flow characteristic information and the network behavior information determined from the flow characteristic information) on the flow characteristic information received for the multiple firewalls to obtain the aggregated analysis result, and on the basis of the aggregated analysis result, determine the control instruction to be sent down to each firewall so that each firewall can control the network data passing through which on the basis of the control instruction received.

Next, an embodiment of the present invention is described by using the multiple firewalls deployed in the distributed manner as an example; FIG. 3 is an illustration, based on the embodiment of the present system for controlling network data, which consists of multiple firewalls that uses distributed deployment; as shown in FIG. 3, the firewalls comprise: multiple firewalls which are deployed in a distributed manner communicate with the firewall analysis device.

It should be noted that in an embodiment of the present invention, because multiple firewalls deployed in a distributed manner are used to distribute the network data transferred in between the first device and the second device, in order to differentiate eight from the existing firewalls, the firewalls deployed in a distributed manner is called the flow firewall in the present application.

It differs from the prior art in that in the network data control system provided in the embodiment of the present application, each flow firewall report the flow characteristic information of the network data passing through itself to the firewall analysis device so that the firewall analysis device can perform aggregated analysis on the network data received from the multiple flow firewalls (including but not limited to performing aggregated analysis on the flow characteristic information and the network behavior information determined by the flow characteristic information) to obtain an aggregated analysis result, so as to, on the basis of the aggregated analysis results, determine the control instruction to be sent down to each firewall for controlling the network data passing through each firewall, thus solving the problem that a single firewall is unable to know all the network data coming from the same network address (for example, the IP address) and is susceptible to an IP-based network attack.

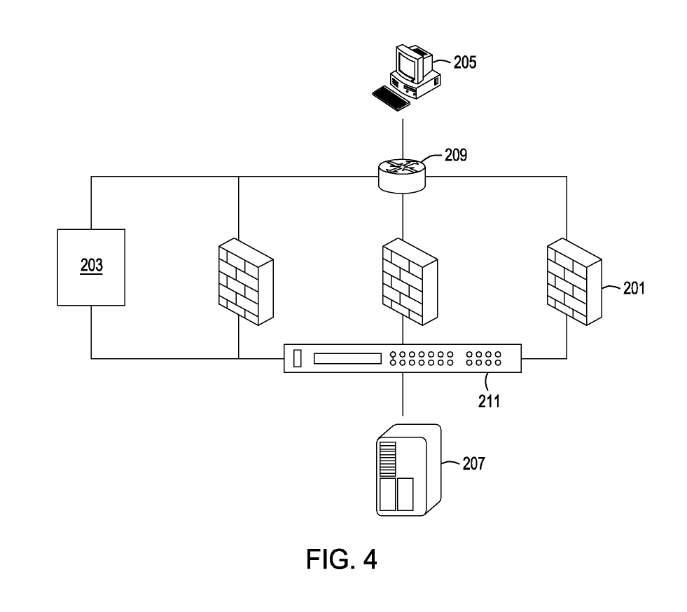

Taking the case that the first device is the device to be protected as an example, in an optional embodiment, as shown in FIG. 4, the above-mentioned system also comprises: a router 209, connected in between each firewall and the second device, for transferring the network data in between the second device and each firewall; and exchanger 211, connected in between each firewall and the first device, for transferring the network data between each firewall and the first device.

Specifically, in the above-mentioned embodiment, the first device is the device to be protected, which may be a device that has no access to network, or a device located in an intranet or a private network; when the first device may be located in a public network, extranet or a device that is in a network different from that of the first device. For example, the first device may be an intranet server as shown in FIG. 3, and the second device may be a server of an Internet service provider located in a public network.

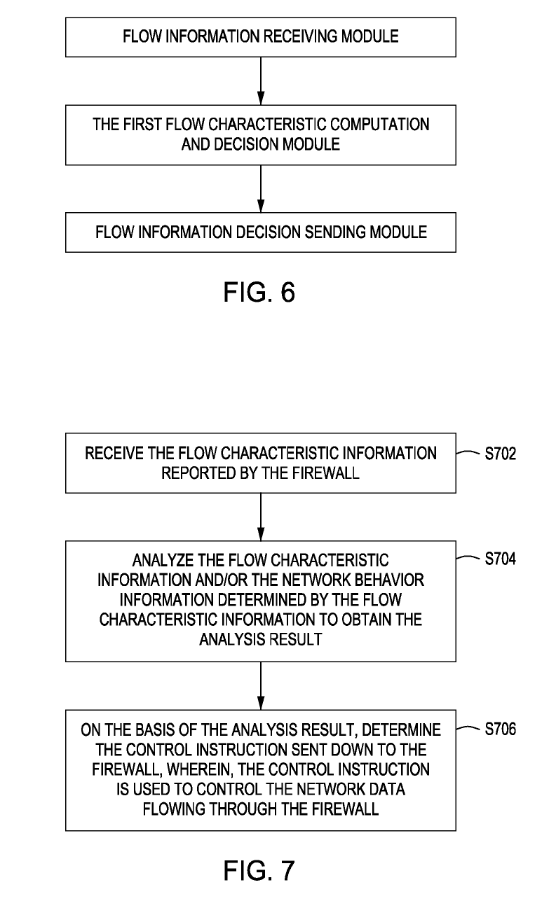

In order to realize the function of the above-mentioned firewall analysis device, in an optional embodiment, as shown in FIG. 6, the firewall analysis device may include the following modules: a flow information receiving module, for receiving the flow characteristic information reported by at least one firewall; a first flow characteristic computation and decision module, which is connected with the flow information receiving module, for analyzing the flow characteristic information reported by at least one firewall to obtain the analysis result, and on the basis of the analysis result, determining the control instruction to be sent down to each firewall; a flow-information-decision-sending module, which is connected with the first characteristic computation and decision module, for sending the control instruction down to the corresponding firewall.

Specifically, the flow characteristic information sent from the flow firewall is received by means of the above-mentioned flow information receiving module, and is sent to the first flow characteristic computation and decision module for processing. By means of the flow characteristic computation and decision module and according to the data collected by the flow-characteristic-extracting module, calculate the behavior information, such as the communication frequency of the source IP in the flow, the similarity of the communication data packet header and the similarity of the returned information, so as to perform subsequent actions on the basis of the pre-configured flow rule and the flow behavior. After determining the predefined actions to be implemented on the network data, the decision behavior of the network data can be sent down to the corresponding flow firewall device by means of the flow-information-decision-sending module to intervene a specific flow.

It is easily noticed that the interior structure of the first flow characteristic computation and decision module is a series of modules for rule testing and matching. Wherein, the flow rule may include the frequency constraint for the flow sending/receiving packet, the size limit of the data of the flow sending/receiving packet, flow header characteristic load limit, and the flow content characteristic matching etc. The flow behaviors include flow blocking, flow discarding, source IP blocking, and the paired flow behavior such as source IP plus source port blocking etc.

In order to realize the function of the above-mentioned firewall extracting the flow characteristic information, in an optional embodiment, the above-mentioned firewall may include: a flow-filtering-engine module, which is used, in the case of acquiring the network data packet passing through each firewall, and on the basis of the filtering rule of each firewall, to inspect the contents of the network data packet and to filter the inspection result to obtain the network data packet that has passed the inspection; a flow-characteristic-extracting module, which is connected with the flow-filtering-engine module, for extracting the flow characteristic information of the network data packet that has passed the inspection.

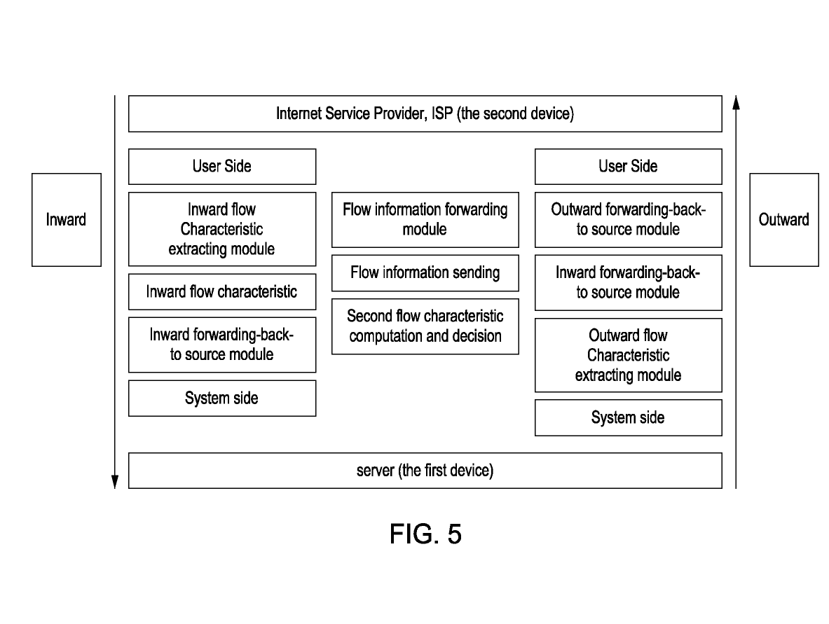

Specifically, as shown in FIG. 5, the directions of the network data passing through the firewall are different, the direction where the first device (the device to be protected) sends data to the second device is called the inward direction, while the direction where the second device sends data to the first device is called the outward direction, thus the flow-filtering-engine module of the above-mentioned firewall may include: an inward direction flow-filtering-engine module and an outward direction flow-filtering-engine module, wherein, the inward direction flow-filtering-engine module is used to inspect and filter the flow contents sent from the first device to the second device; and the outward direction flow-filtering-engine module is used to inspect and filter the flow contents sent from the second device to the first device. The flow-characteristic-extracting module of the above-mentioned firewall may include: an inward flow-characteristic-extracting module and an outward flow-characteristic-extracting module, wherein, the inward flow-characteristic-extracting module is used to extract the flow characteristic information of the network data sent from the first device to the second device; and the outward flow-characteristic-extracting module is used to extract the flow characteristic information of the network data sent from the second device to the first device.

Further, after the firewall has acquired the network data passing through the firewall by means of the flow-filtering-engine module and heavy extracted the flow characteristic information by means of the flow-characteristic-extracting module, the firewall can determine the corresponding operation to be implemented on the contents of the network flow that passes through the firewall on the basis of the flow rule and flow behavior configured in the firewall; hence, based on the above mentioned embodiment, as an optional embodiment, the above-mentioned firewall may also include: a second flow characteristic computation and decision module, connected with the flow-characteristic-extracting module, for determining, on the basis of the flow characteristic information of the network data packet obtained through filtering by the flow-filtering-engine module, the predefined operation to be implemented by each firewall on the network data packet that passes through the firewall; and a flow-information-receiving/sending module (a flow-information-receiving/sending module), connected respectively with the second flow characteristic computation and decision module and the flow information receiving module of the firewall analysis device, for sending the flow characteristic information of the network data packet that passes through the second flow characteristic computation and decision module to the flow information receiving module of the firewall analysis device.

Specifically, the above-mentioned predefined operation includes but is not limited to at least one of the following: forwarding the network data packet, discarding the network data packet, and blocking the network data packet; the above-mentioned second flow characteristic computation and decision module, according to the data collected by the flow-characteristic-extracting module, calculates the behavior information, such as the communication frequency of the source IP in the flow, the similarity of the communication data packet header and the similarity of the returned information. Subsequent actions are performed according to the pre-configured flow rule and flow behavior. The interior structure thereof is a series of modules for rule testing and matching. Wherein, the flow rule may include the frequency constraint for the flow sending/receiving packet, the size limit of the data of the flow sending/receiving packet, flow header characteristic load limit, and the flow content characteristic matching etc. The flow behaviors include flow blocking, flow discarding, source IP blocking, and the paired flow behavior such as source IP plus source port blocking etc.

Through the above mentioned embodiment, each firewall deployed in a distributed manner can perform a preliminary screening operation on the network flow contents according to the flow rule and flow behavior configured therein, so as to discard or block the network data packet which does not meet the flow rule, and only the network data packet that passes the decision of each firewall can be sent through the flow information sending/receiving module to the first flow characteristic computation and decision module of the firewall analysis device, reducing the burden of processing for the firewall analysis device and improving work efficiency.

As an optional embodiment, the above-mentioned firewall may also include: a forwarding-back-to-source module, connected with the first flow characteristic computation and decision module, for forwarding the network data packet which is permitted by the first flow characteristic computation and decision module to be forwarded by the firewall; a flow-information-forwarding-management module, connected to the forwarding-back-to-source module, for providing, to the forwarding-back-to-source module, the target network address and the target port information of the network data packet that passes through the firewall.

Specifically, when the direction that the first device (the device to be protected) sends data to the second device is called the inward direction, and the direction that the second device sends data to the first device is called the outward direction, the above-mentioned forwarding-back-to-source module may include: an inward forwarding-back-to-source module and an outward forwarding-back-to-source module, wherein, when the data packet arrives at the inward forwarding-back-to-source module, the inward forwarding-back-to-source module will inquire concerning the back to source configuration (need to be configured in advance, that is, to configure the forwarding mapping relationship) from the flow-information-forwarding-management module using the target port information, and lastly forwarding the data to an assigned IP address that has been pre-configured. Now, the source IP and the source port information to be used in forwarding will be sent to the flow-information-forwarding-management module to be saved for the flow of the outward direction to inquire; when the data packet arrives at the outward forwarding-back-to-source module, the outward forwarding-back-to-source module will use the source IP and the source port information to inquire of the flow-information-forwarding-management module for the original inward data information, and return the data packet following the source route.

### Embodiment 2

According to the embodiment of the present application, also provided is an embodiment for a network data control method, this embodiment can be applied in the network data control system in Embodiment 1, including but not limited to the scenario in Embodiment 1. It is to be noted that the steps as shown in the flowchart of the drawings can be implemented in a computer system, such as a group of computer implementable instructions, and although a logic sequence is shown in the flowchart, in some situations, the steps shown or described may be implemented in an order different from the one herein.

In the prior art, multiple firewalls are used in parallel to form a firewall group so as to realize the function of a traditional single firewall, although it has overcome the problem that a single firewall access meeting the network service or applications be influenced by the firewall bandwidth; however, because network data are distributed when passing through multiple firewalls, each firewall can't only inspect and filter the data passing through itself, and is unable to know the whole picture of the entire IP data. This firewall mode is unable to monitor an IP-based network attack.

In order to solve the above-mentioned problem, the present application provides an embodiment for a network control method. FIG. 7 is a flowchart, based on the embodiment of the present application, of a network data control method; as shown in FIG. 7, it comprises the following steps:

Step S702, receiving the flow characteristic information reported by the firewall.

Specifically, the above-mentioned firewall may be but not is limited to the firewall for network security protection between an intranet and an extranet, between a private network and a public network, and between a user terminal (any device that is accessible to network, including but not limited to a cell phone, a laptop computer, a computer, and a tablet etc.) and the network it connects with. Optionally, the above-mentioned firewall may be one or more, when there are multiple firewalls, the above-mentioned flow characteristic information may be the flow characteristic information reported by the multiple firewalls.

Optionally, the above-mentioned flow characteristic information includes but is not limited to at least one of the following: the source network address and the source port information which send the network data packet; the target network address and the target port information which receive the network data packet; the information of the size of the network data packet; the information of the header of the network data packet; the information for the protocol label of the network data packet; the sending time of the network data packet and the receiving time of the network data packet.

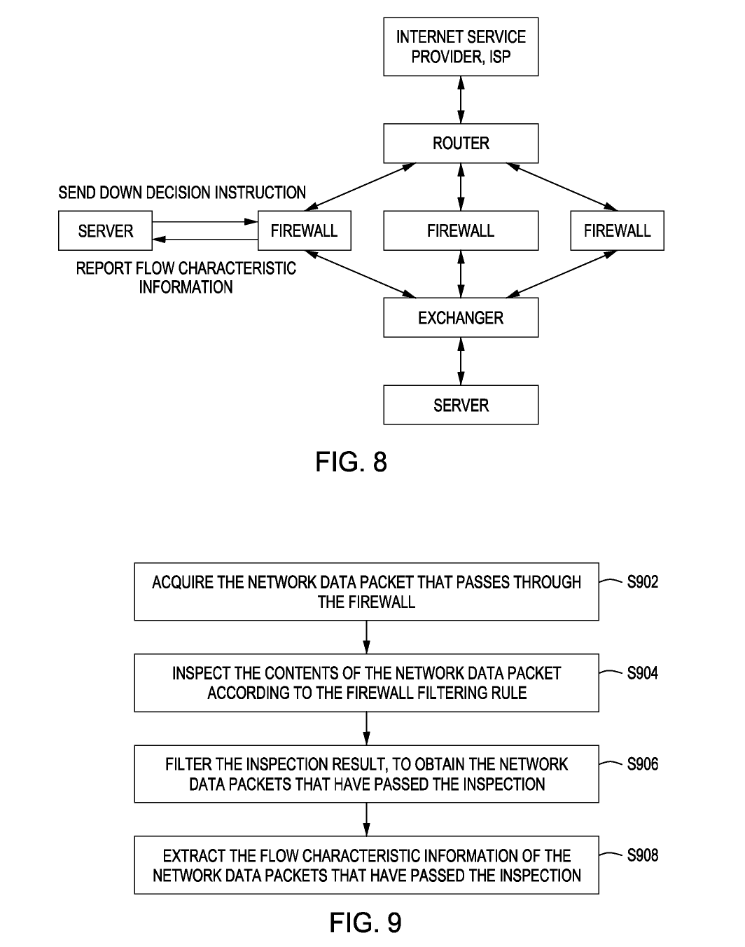

As an optional embodiment, the flow characteristic information reported by multiple firewalls which are deployed in a distributed manner can be received by means of a firewall analysis device. FIG. 8 is an illustration of an optional protection structure of the firewall on the basis of the embodiment of the present application, as shown in FIG. 8, when the carrier data at the Internet Service Provider (ISP) side enters a router, the network data will be distributed, by means of the router, on to multiple firewalls which are deployed in a distributed manner, and the firewall analysis device can receive the flow characteristic information reported by each firewall.

Step S704, analyze the flow characteristic information and/or the network behavior information determined from the flow characteristic information to obtain the analysis results.

Specifically, through step S702, after receiving the flow characteristic information of the network data that pass through and are reported by each firewall, the flow characteristic information of all the firewalls and/or the network behavior information determined from the flow characteristic information can be analyzed comprehensively through the above-mentioned step S704 to obtain the corresponding analysis results. Optionally, it may only perform analysis on the flow characteristic information reported by the firewall, or determine the corresponding network behavior information on the basis of the flow characteristic information reported by the firewall and perform analysis on the network behavior information, or perform comprehensive analysis on the flow characteristic information and the network behavior information. Further, in the case that there are multiple firewalls, it can perform an aggregated analysis on the flow characteristic information of the multiple firewalls and/or the corresponding network behavior information, so as to determine the control instruction to be sent down on the basis of the result from the aggregated analysis.

Still taking the protection framework as shown in FIG. 8 as an example, when the firewall analysis device receives the flow characteristic information reported by each firewall, it performs comprehensive analysis on the flow characteristic information for all the firewalls and obtains the corresponding analysis results.

Step S706, determining the control instruction to be sent down to the firewalls on the basis of the analysis result, wherein, the control instruction is used to control the network data passing through the firewall.

Specifically, because each firewall can only know the network data passing through itself, indicating that the network data of a certain IP are distributed to multiple firewalls for protection, there are security risks when depending only on each firewall to protect their respective network data. While it is only by receiving the flow characteristic information reported by each firewall through the above-mentioned step S702, according to the step S704, performing comprehensive analysis on the flow characteristic information for each firewall, and determining the control instruction to be sent down to each firewall through the above-mentioned step S706 and on the basis of the analysis result obtained in step S704, that the firework can be accurately controlled to implement corresponding operations.

For example, when the rule of firewall filtering is such that a data packet can smoothly pass a firewall if the number of data packets coming from the same IP address is not greater than N, however, if the data packets of a certain IP address are to be protected through three firewalls, and if the number of the network data packets detected by each firewall is 0.5N, then the network data packets of the IP address will smoothly pass through each firewall. However, actually, if the network data packets for the three firewalls are analyzed together, it can be determined that the number of the network data packets from the IP address is 1.5N, which has exceeded the predefined number N; hence, the firewalls shall be controlled to block or discard the network data packets from the IP address.

It is to be noted that the above-mentioned control instruction is used to control the firewall to implement predefined operations including but not limited to at least one of the following: forwarding network data packets, discarding network data packets, and blocking network data packets. That is, the network data packets that have passed the firewall flow rule can be forwarded out by the firewall, while the network data packets that have failed to pass the firewall flow rule will be discarded or blocked by the firewall.

Hence, in the solution disclosed in the above-mentioned Embodiment 2 of the present application, by receiving the flow characteristic information reported by each firewall and by performing analysis on the flow characteristic information reported by each firewall to obtain the analysis result, the control instruction can be determined, according to the analysis result, to be sent down to each firewall for controlling the network data passing through the firewall.

It is easily noticeable that the above-mentioned firewall can be one or more, in the case that there are multiple firewalls, the multiple firewalls can be deployed in a distributed manner to meet the objective that to limit network data by distributing them in multiple firewalls to overcome the bandwidth limitation and to perform comprehensive analysis on the network data to overcome network attack, thus realizing the technical effect of improving the network protection performance.

Hence, the solution of the above-mentioned Embodiment 2 provided in the present application has solved the technical problem in the existing firewall modes in terms of their poor performance in protecting network data.

In an optional embodiment, as shown in FIG. 9, before receiving the flow characteristic information reported by the firewall, the above-mentioned method may comprise the following steps:

Step S902, acquiring the network data packet that passes through the firewall, wherein, the network data packet comprises at least one of the following: the inward data packet that flows into the intranet and the outward data packet that flows outside the intranet.

Specifically, in the above step, before the firewall analysis device receiving the flow characteristic information of the network the data packet reported by each firewall, that is, before each firewall reporting their respective flow characteristic information of the network data packet, each firewall is required to acquire the network data packet that passes through itself, optionally, each firewall may acquire the data packet (that is the inward data packet) that flows into the intranet server, or acquire the data packet (that is the outward data packet) that flows out of the intranet server.

Step S904, inspecting the contents of the network data packet according to the firewall filtering rule.

Specifically, the above-mentioned filtering rule may be a flow rule that is pre-configured in each firewall to be used for each firewall to screen and filter the network data packet passing through itself so as to discard or block the network data packets that are not in conformity with the rule or have security risks, optionally, it can inspect the contents of the network data packets that pass through the firewall, including but not limited to the following information: flow receiving/sending packet frequency constraint, flow receiving/sending packet data size limit, flow hider characteristic load limit, and flow content characteristic matching etc. Correspondingly, when configuring the flow rules for each through wall, it can configure the behaviors to be implemented by the firewall, including but not limited to any of the following: blocking or discarding a data packet, blocking or discarding a data packet from a source IP, blocking or discarding a data packet coming from a source IP address and source port information.

Step S906, filtering the inspection result, to obtain the network data packets that have passed the inspection.

Specifically, after each firewall has acquired the network data packet that pass through itself, it can, according to the filtering rule of each firewall, perform inspection on the contents of the network data packet and filter the inspection result and filter out the network data that have passed the firewall inspection; optionally, the data packets that have failed the firewall inspection can be either discarded or blocked.

Step S908, extracting the flow characteristic information of the network data packets that have passed the inspection.

Specifically, after inspecting and filtering, according to the pre-configured filtering rule, the network data packets that pass through the firewall, each firewall only extracts the flow characteristic information of the network data packet that has passed the inspection of each firewall, so as to allow the firewall analysis device to perform aggregated analysis only on the network data packets that have passed the firewall inspection.

Through the above-mentioned embodiment, each firewall may extract the flow characteristic information of the network data packet that has passed the firewall inspection, so as to allow the firewall analysis device to inspect and make decisions only on the network data packets that have passed the inspection of each firewall, thus improving the processing efficiency for the firewall.

As an optional embodiment, in the case of multiple firewalls, receive the flow characteristic information reported by the multiple firewalls, wherein, the flow characteristic information are those of the network data packet that has passed the inspection of each firewall.

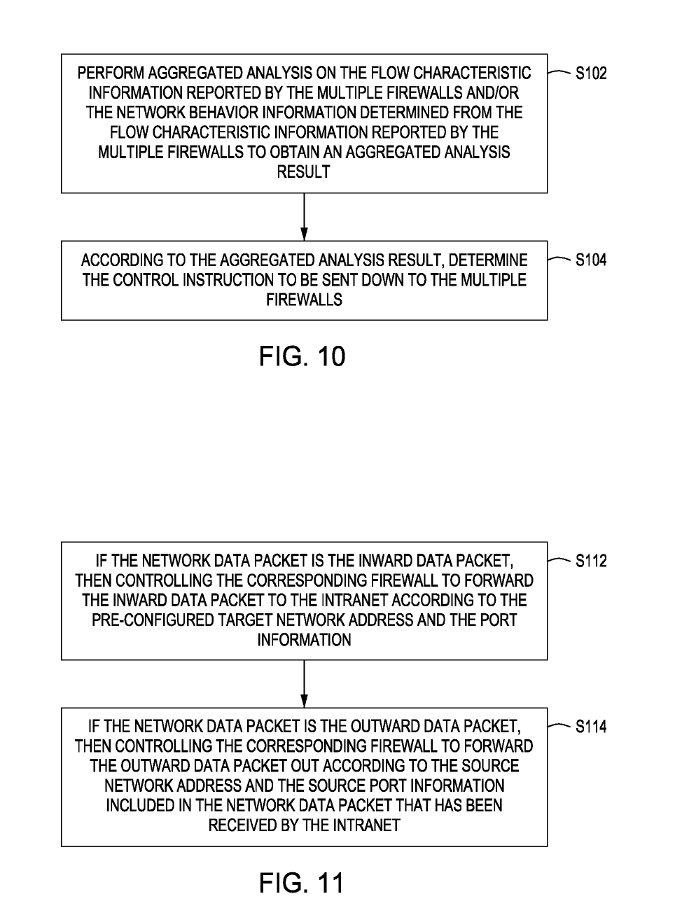

Based on the above-mentioned embodiment, as an optional embodiment, as shown in FIG. 10, analyze the flow characteristic information and/or the network behavior information determined from the flow characteristic information to obtain the analysis result, and according to the analysis result determine the control instruction to be sent down to the firewall, which may include:

Step S102, performing aggregated analysis on the flow characteristic information reported by the multiple firewalls and/or the network behavior information determined from the flow characteristic information reported by the multiple firewalls to obtain an aggregated analysis result;

Step S104, according to the aggregated analysis result, determining the control instruction to be sent down to the multiple firewalls.

Specifically, in the above-mentioned embodiment, the firewall analysis device may receive the flow characteristic information reported by multiple firewalls and perform aggregated analysis on the flow characteristic information received from the multiple firewalls, or determine the corresponding network behavior information according to the flow characteristic information reported by the multiple firewalls, and perform aggregated analysis on the network behavior information determined from the flow characteristic information reported by the multiple firewalls to obtain the aggregated analysis result, and according to the aggregated analysis result determine the control instruction to be sent down to each firewall so that each firewall can, according to the control instruction received, control the network data that pass through itself.

In an optional embodiment, the control instruction to be sent down to the multiple firewalls is determined according to the aggregated analysis result, including: determining whether the flow characteristic information of the network data packet that has passed the inspection of each firewall matches the predefined flow characteristic; in the situation that the flow characteristic information of the network data packet that has passed the inspection of each firewall matches the predefined flow characteristics, a control instruction will be sent down to the corresponding firewall, wherein, the control instruction is used to control the firewall to implement predefined operations that corresponds to the predefined flow characteristics on the network data packet that has passed the firewalls.

Optionally, the above-mentioned predefined flow characteristics include but are not limited to at least one of the following: the frequency for receiving/sending the network data packet, the size of the network data packet, the header information load limit for the network data packet, and the degree of matching of the content of the network data packet. Wherein, the predefined operations include but are not limited to at least one of the following: forwarding network data packets, discarding network data packets, and blocking network data packets.

In another optional embodiment, the control instruction to be sent down to the multiple firewalls is determined according to the aggregated analysis result, including: according to the flow characteristic information of the network data packet that has passed the inspection of each firewall, determining the network behavior information of the network data packet that has passed the inspection of each firewall; determining whether the network behavior information of the network data packet that has passed the inspection of each firewall match the predefined network behavior rule; in the situation that the network behavior information of the network data packet that has passed the inspection of each firewall match the predefined network behavior rule, sending the control instruction down to the corresponding firewall, wherein, the control instruction is used to control the firewall to implement the predefined operation corresponding to the predefined network behavior on the network data packet that passes through the firewalls.

Optionally, the above-mentioned predefined network behavior rule is used to define at least one of the following information: the frequency for receiving/sending the network data packet, the size of the network data packet, the similarity of the header information for the network data packet, and the degree of matching of the content of the network data packet. Wherein, the predefined operations include but are not limited to at least one of the following: forwarding network data packets, discarding network data packets, and blocking network data packets.

Based on any of the above optional embodiments, as an optional embodiment, before receiving the flow characteristic information reported by the multiple firewalls, it may include: determining whether the flow characteristic information of the network data packet that has passed the inspection of each firewall matches the predefined flow characteristic; in the situation that the flow characteristic information of the network data packet that has passed the inspection of each firewall matches the predefined flow characteristics, controlling each firewall to implement a predefined operation that corresponds to the predefined flow characteristics on the network data packet that passes through the firewall. Wherein, the predefined flow characteristics include but are not limited to at least one of the following: the frequency for receiving/sending the network data packet, the size of the network data packet, the header information load limit for the network data packet, and the degree of matching of the content of the network data packet. The predefined operations include but are not limited to at least one of the following: forwarding network data packets, discarding network data packets, and blocking network data packets.

Based on any of the above optional embodiments, and as another optional embodiment, before receiving the flow characteristic information reported by the multiple firewalls, it may include: according to the flow characteristic information of the network data packet that has passed the inspection of each firewall, determining the network behavior information of the network data packet that has passed the inspection of each firewall; determining whether the network behavior information of the network data packet that has passed the inspection of the firewall match the predefined network behavior rule; in the situation that the network behavior information match the predefined network behavior rule, control each firewall to implement the predefined operation that corresponds to the predefined network behavior rule on the network data packet that passes through the firewall. Wherein, the predefined network behavior rule is used to define at least one of the following information: the frequency for receiving/sending network data packet, the size of the network data packet, the similarity of the header information for the network data packet, and the degree of matching for the content of the network data packet. The predefined operations include but are not limited to at least one of the following: forwarding network data packets, discarding network data packets, and blocking network data packets.

Based on any of the above optional embodiments, as an optional embodiment, in the case that the predefined operation is to forward the network data packet, as shown in FIG. 11, the above-mentioned method may also comprise:

Step S112, if the network data packet is the inward data packet, then controlling the corresponding firewall to forward the inward data packet to the intranet according to the pre-configured target network address and the port information;

Step S114, if the network data packet is the outward data packet, then controlling the corresponding firewall to forward the outward data packet out according to the source network address and the source port information included in the network data packet that has been received by the intranet.

Specifically, in the above-mentioned embodiment, if the inward data packet passes the inspection by the firewall analysis device, then the inward data packet can be forwarded to a device that corresponds to the intranet on the basis of the pre-configured target network address and port information; if the outward network data packet passes the inspection by the firewall analysis device, then the outward data packet can be forwarded to the device that corresponds to an extranet on the basis of the source network address and the source port information of the network data packet stored at the time when the intranet receives the network data packet. For example, the flow-information-forwarding-management module of the firewall as shown in FIG. 6 is used to manage the target address to be forwarded in the outward/inward flow. Wherein, the inward forwarding is required to be pre-configured in order to complete the mapping; and the outward forwarding configuration needs to be provided by the inward forwarding source module.

For example, when a device at the user side sends a request packet (for example, a QQ log in request) for a certain application service, the server providing the application service may, according to the source IP address and the source port number included in the request packet, send the response packet that has been returned by the application server according to the request packet, to the source IP address and the source port number from which the request packet has been sent.

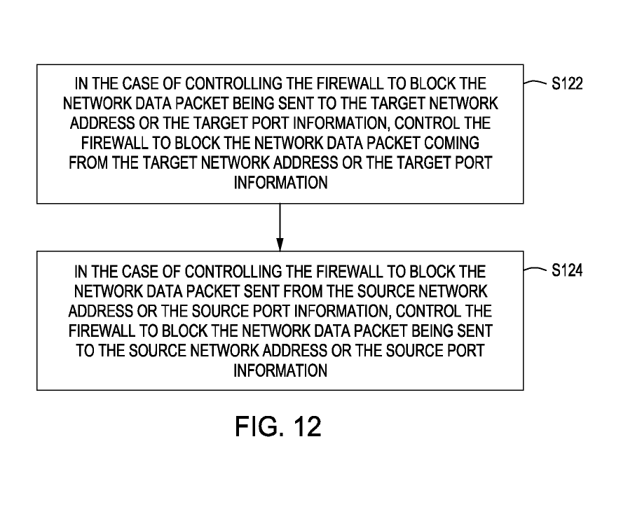

Based on any of the above optional embodiments, as an optional embodiment, in the case that the predefined operation is to block the network data packet, as shown in FIG. 12, the above-mentioned method may also comprise:

Step S122, in the case of controlling the firewall to block the network data packet being sent to the target network address or the target port information, control the firewall to block the network data packet coming from the target network address or the target port information;

Step S124, in the case of controlling the firewall to block the network data packet sent from the source network address or the source port information, control the firewall to block the network data packet being sent to the source network address or the source port information.

Through the above-mentioned step S122, in the case that the firewall analysis device, according to the flow characteristic information reported by the multiple firewalls, sends down to the corresponding firewall the control instruction to block the network data packet being sent to a certain target network address or target port information, the firewall analysis device can be used to send down the control instruction to the firewall for blocking the network data packet sent from the target network address for the target port information, so as to realize the objective of controlling the flow; or, in the case that according to the pre-configured flow rule, the firewall determines that the firewall needs to block the network data packet being sent to a certain target network address or target port information, the firewall can be controlled simultaneously to block the network data packet sent from the target network address or the target port information, so as to realize the objective of controlling the flow.

Through the above-mentioned step S124, in the case that the firewall analysis device, according to the flow characteristic information reported by the multiple firewalls, sends down to the corresponding firewall the control instruction to block the network data packet sent from a certain source network address or source port information, the firewall analysis device can be used to send down the control instruction to the firewall for blocking the network data packet being sent to the source network address or the source port information, so as to realize the objective of controlling the flow; or, in the case that according to the pre-configured flow rule, the firewall determines that the firewall needs to block the network data packet sent from a certain source network address or source port information, the firewall can be controlled simultaneously to block the network data packet being sent to the source network address or the source port information, so as to realize the objective of controlling the flow.

Taking the firewall analysis device as shown in FIG. 5 and the firewall as shown in FIG. 6 as an example, when the network data control method provided in the embodiment of the present application is applied to specific services, the service processing process for the firewall includes the following two aspects:

(1) The inward processing process: the inward flow-filtering-engine module receives the data packet coming from the ISP side to start the flow information filtering. The data packet that has passed the inspection by the flow-filtering-engine module then enters the inward flow-characteristic-extracting module for characteristics extraction, otherwise, the data packet will be subject to subsequent action processing (for example, discarding, breaking the flow etc.) according to the behavior configured in the filter. The flow characteristic extracting mobile extracts the flow information in the data packet before transferring to the flow characteristic computation and decision module for processing. If it matches the local flow characteristic or a fated flow rule, then the flow characteristic computation and decision module add rules and actions to the inward flow-filtering-engine module and the outward flow-filtering-engine module to intervene in the designated flow. After the flow characteristic computation and decision module completes the processing, the aggregated data are transferred to the flow-information-receiving/sending module and are forwarded by the module to the firewall flow analysis device for centralized decision. Lastly, the flow information that have passed the inspection enters the inward forwarding-back-to-source module, where the final forwarding target address is found for flow information forwarding by inquiry to the configuration of the flow-information-forwarding-management module.

(2) The outward processing process: the outward flow-filtering-engine module receives the data packet coming from the server side to start the flow information filtering. The data packet that has passed the inspection by the flow filtering engine then enters the outward flow-characteristic-extracting module for characteristics extraction, otherwise, the data packet will be subject to subsequent action processing (for example, discarding, breaking the flow etc.) according to the behavior configured in the filter. The flow characteristic extracting mobile extracts the flow information in the data packet before transferring to the flow characteristic computation and decision module for processing. If it matches the local flow characteristic or a fated flow rule, then the flow characteristic computation and decision module add rules and actions to the outward flow-filtering-engine module and the inward flow-filtering-engine module to intervene in the designated flow. After the flow characteristic computation and decision module completes the processing, the aggregated data are transferred to the flow-information-receiving/sending module and are forwarded by the module to the firewall flow analysis device for centralized decision. Lastly, the flow information that has passed the inspection enters the outward forwarding-back-to-source module, where the returning target address for the data inward direction is found for flow information forwarding by inquiry to the configuration of the flow-information-forwarding-management module.

The process of the firewall flow analysis device intervening in the flow behavior is: once the flow information receiving module receives the flow information, the flow analysis is started. When the fated corresponding rule is founded for the flow characteristic in the flow characteristic computation and decision module, then the flow-information-decision-sending module will be notified to send to the corresponding flow firewall device for the designated flow characteristics and for the action information for the flow.

It is to be noted that for the previously mentioned embodiments of methods, in order to simplify the description, these are described as a combination of a series of actions, however, a person skilled in the art shall know that the present application is not limited to the described order of actions, because according to the present application, some steps may use other orders or be implemented simultaneously. Secondarily, a person skilled in the art may also know that the embodiment described in the specification are all preferred embodiments, and the related actions and more dues are not necessarily required in the present application.

Through the description of the above implementation method, a person skilled in the art can clearly know that the network data control method according to the above-mentioned embodiment, can be realized using software plus a necessary general hardware platform, and of course it can use hardware, but in many cases the former is a better implementation method. Based on such understanding, the essence of the technical solution of the present application or the part thereof that has contribution to prior arts can be embodied in the form of software products, wherein the computer software products are stored in the storage medium (such as ROM/RAM, disk and CD), and include several instructions used to allow a terminal device (probably a cell phone, computer, server or network device etc.) to implement the method described in the embodiments of the present application.

### Embodiment 3

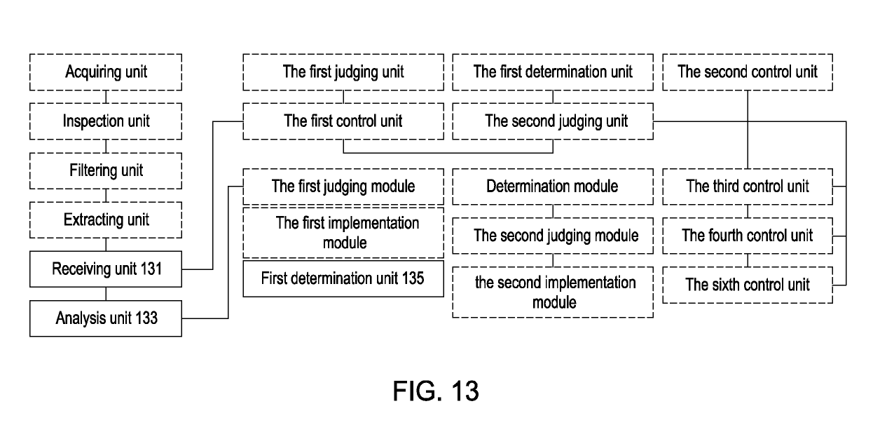

According to an embodiment of the present application, also provided is an embodiment of a device used to realize the above mentioned network data control method; FIG. 13 is an illustration, based on the embodiment of the present application, of a network data control device; as shown in FIG. 13, the device comprises: a receiving unit 131, and analysis unit 133 and a first determination unit 135.

wherein, the receiving unit 131 is used to receive the flow characteristic information reported by the firewall;

the analysis unit 133 is used to analyze the flow characteristic information and/or the network behavior information determined from the flow characteristic information to obtain the analysis results; and

the first determination unit 135 is used to determine the control instruction to be sent down to the firewalls on the basis of the analysis result, wherein, the control instruction is used to control the network data passing through the firewall.

It is to be noted here that the above-mentioned receiving unit 131, the analysis unit 133 and the first determination unit 135 correspond to the steps S702 to S706 in Embodiment 2, where the examples and the application scenarios realized by the above modules and the corresponding steps are the same, but are not limited to the contents disclosed in Embodiment 2. It is to be noted that the above-mentioned modules, as a part of the device, can be implemented in the computer system such as a group of computer implementable instructions.

Hence, in the solution disclosed in the above-mentioned Embodiment 3 of the present application, the receiving unit 131 is used to receive the flow characteristic information reported by each firewall and the analysis unit 133 is used to perform analysis on the flow characteristic information reported by each firewall to obtain the analysis result, so that the first determination unit 135 can be used to determine the control instruction to be sent down to each firewall for controlling the network data passing through the firewall according to the analysis result.

It is easily noticeable that the above-mentioned firewall can be one or more, in the case that there are multiple firewalls, the multiple firewalls can be deployed in a distributed manner to meet the objective that to limit network data by distributing which in multiple firewalls to overcome the bandwidth limitation and to perform comprehensive analysis on the network data to overcome network attack, thus realizing the technical effect of improving the network protection performance.

Hence, the solution of the above-mentioned Embodiment 3 provided in the present application has solved the technical problem in the existing firewall modes in terms of their poor performance in protecting network data.

In an embodiment, the above-mentioned device may also comprise: an acquiring unit, which is used to acquire the network data packet that passes through the firewall, wherein, the network data packet comprises at least one of the following: the inward data packet that flows into the intranet and the outward data packet that flow out of the intranet; an inspection unit, which is used to inspect the contents of the network data packet according to the filtering rule of the firewall; a filtering unit, which is used to filter the inspection result to obtain the network data packet that has passed the inspection; the extraction unit, which is used to extract the flow characteristic information of the network data packet which have passed the inspection.

In optional embodiment, the above-mentioned flow characteristic information may include at least one of the following: the source network address and the source port information which send the network data packet; the target network address and the target port information which receive the network data packet; the information of the size of the network data packet; the information of the header of the network data packet; the information for the protocol label of the network data packet; the sending time of the network data packet and the receiving time of the network data packet.

In an embodiment, the above-mentioned receiving unit is also used, in the case of multiple firewalls, to receive the flow characteristic information reported by the multiple firewalls, wherein, the flow characteristic information are those of the network data packet that has passed the inspection of each firewall.

In an embodiment, the above-mentioned analysis unit can also be used to perform aggregated analysis on the flow characteristic information reported by the multiple firewalls and/or on the network behavior information determined by the flow characteristic information reported by the multiple firewalls, so as to obtain the aggregated analysis result; the above-mentioned first determination unit is also used to determine the control instructions to be sent down to the multiple firewalls according to the aggregated analysis result.

In an embodiment, the above-mentioned first determination unit may comprise: a first judging module, which is used to judge whether the flow characteristic information of the network data packet that has passed the inspection by each firewall matches the predefined flow characteristic; a first implementation module, which is used, in the situation that the flow characteristic information of the network data packet that has passed the inspection of each firewall matches the predefined flow characteristics, to send a control instruction down to the corresponding firewall, wherein, the control instruction is used to control the firewall to implement predefined operations that corresponds to the predefined flow characteristics on the network data packet that has passed the firewalls.

In an embodiment, the above-mentioned first determination unit may comprise: a determination module, which is used, according to the flow characteristic information of the network data packet that has passed the inspection of each firewall, to determine the network behavior information of the network data packet that has passed the inspection of each firewall; a second judging module, which is used to judge whether the network behavior information of the network data packet that has passed the inspection by each firewall matches the predefined network behavior rule; a second implementation module, which is used, in the situation that the network behavior information of the network data packet that has passed the inspection of each firewall match the predefined network behavior rule, to send the control instruction down to the corresponding firewall, wherein, the control instruction is used to control the firewall to implement the predefined operation corresponding to the predefined network behavior on the network data packet that passes through the firewalls.

In an optional embodiment, the above-mentioned device may also comprise: a first judging unit, which is used to judge whether the flow characteristic information of the network data packet that has passed the inspection by each firewall matches the predefined flow characteristic; a first control unit, which is used, in the situation that the flow characteristic information of the network data packet that has passed the inspection of each firewall matches the predefined flow characteristics, to control each firewall to implement a predefined operation that corresponds to the predefined flow characteristics on the network data packet that passes through the firewall.

In an optional embodiment, the above-mentioned device may also comprise: a second determination unit, which is used, according to the flow characteristic information of the network data packet that has passed the inspection of each firewall, to determine the network behavior information of the network data packet that has passed the inspection of each firewall; a second judging unit, which is used to judge whether the network behavior information of the network data packet that has passed the inspection of the firewall match the predefined network behavior rule; and a second control unit, which is used, in the situation that the network behavior information match the predefined network behavior rule, to control each firewall to implement the predefined operation that corresponds to the predefined network behavior rule on the network data packet that passes through the firewall.

As an optional embodiment, the above-mentioned predefined flow characteristics may include at least one of the following: the frequency for receiving/sending network data packet, the size of the network data packet, the header information load limit for the network data packet, and the degree of matching of the content of the network data packet.

As an optional embodiment, the above-mentioned predefined network behavior rule may be used to define at least one of the following information: the frequency for receiving/sending the network data packet, the size of the network data packet, the similarity of the header information for the network data packet, and the degree of matching of the content of the network data packet.

As an optional embodiment, the above-mentioned predefined operations may include at least one of the following: forwarding network data packets, discarding network data packets, and blocking network data packets.

In an optional embodiment, when the predefined operation is to forward the network data packet, the above-mentioned device may also comprise: a third control unit, which is used, if the network data packet is an inward data packet, to control the corresponding firewall, on the basis of the pre-configured target network address and the port information, to forward the inward data packet to the intranet; a fourth control unit, which is used, if the network data packet is the outward data packet, to control the corresponding firewall to forward the outward data packet out according to the source network address and the source port information included in the network data packet that has been received by the intranet.

In an optional embodiment, when the predefined operation is to block the network data packet, the above device may also comprise: a fifth control unit, which is used, in the situation of controlling the firewall to block the network data packet being sent to the target network address or the target port information, to control the firewall to block the network data packet coming from the target network address or the target port information; a sixth control unit, which is used, in the situation of controlling the firewall to block the network data packet that comes from the source network address or the source port information, to control the firewall to block the network data packet to be sent to the source network address or the source port information.

### Embodiment 4

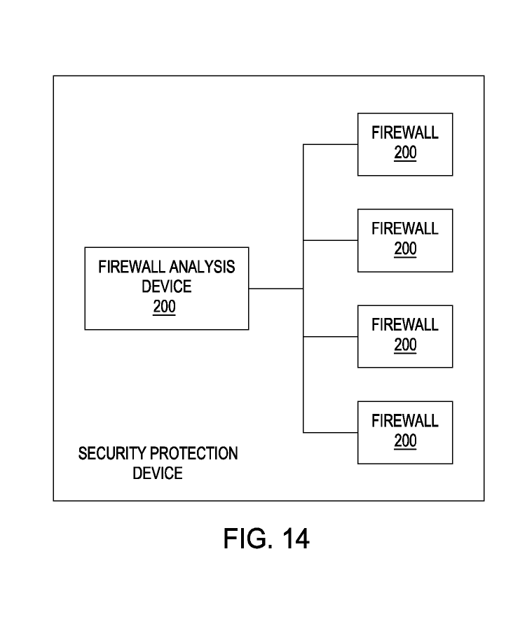

According to the embodiment of the present application, also provided is an embodiment of a security protection device used to realize the above mentioned network data control method; FIG. 14 is an illustration, based on the embodiment of the present application, of a security protection device; as shown in FIG. 14, the security protection device comprises: a firewall 141 and a firewall analysis device 143.

Wherein, the firewall 141 is used to acquire the network data and to extract the flow characteristic information of the network data; and the firewall analysis device 143 communicates with the firewall for receiving the flow characteristic information reported by the firewall; analyzing the flow characteristic information and/or the network behavior information determined by the flow characteristic information to obtain the analysis result; and on the basis of the analysis result, determining the control instruction to be sent down to the firewall, wherein, the control instruction is used to control the network data passing through the firewall.

Optionally, the above-mentioned firewall may include but is not limited to the functional modules as shown in FIG. 6, and the above-mentioned firewall analysis device 143 may include but is not limited to the functional modules as shown in FIG. 5.

Hence, in the solution disclosed in the above-mentioned Embodiment 4 of the present application, the firewall 141 is used to receive the flow characteristic information reported by each firewall and the firewall analysis device 143 is used to perform analysis on the flow characteristic information reported by each firewall to obtain the analysis result, so as to determine the control instruction to be sent down to each firewall for controlling the network data passing through the firewall according to the analysis result.

It is easily noticeable that the above-mentioned firewall can be one or more, in the case that there are multiple firewalls, the multiple firewalls can be deployed in a distributed manner to meet the objective that to limit network data by distributing them in multiple firewalls to overcome the bandwidth limitation and to perform comprehensive analysis on the network data to overcome network attack, thus realizing the technical effect of improving the network protection performance.

Hence, the solution of the above-mentioned Embodiment 4 provided in the present application has solved the technical problem in the existing firewall modes in terms of their poor performance in protecting network data.

### Embodiment 5

The embodiment of the present application may provide a computer device, which may be any computer device in a computer device group. Optionally, in the present embodiment, the above-mentioned computer device may be replaced with a terminal device, such as a computer device.

Optionally, in the present embodiment, the above-mentioned computer device may be at least one access device in multiple network devices that are located in a computer network.

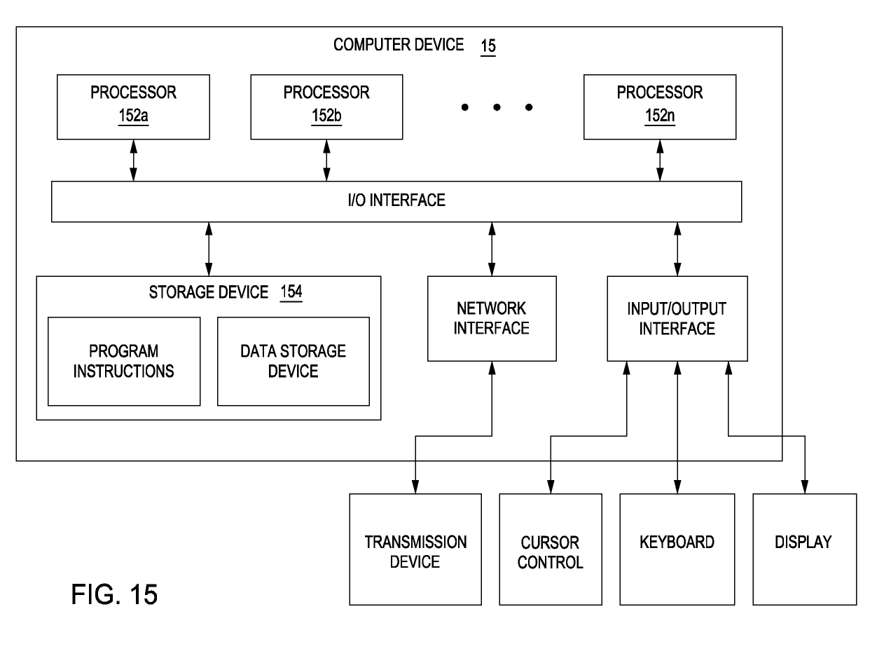

FIG. 15 shows a frame chart of the hardware of a computer device. As shown in FIG. 15, the computer device 15 may include one or more (shown in the Fig. with 152a, 152b, . . . , 152n) processors 152 (the processor 152 may include but not limited to processing devices such as a microprocessor MCU or a programmable logic device FPGA etc.), storage devices 154 for storing data, and transmission devices 156 used for communication function. In addition, it may also include: a display, and input/output interface (I/O interface), a universal serial bus (USB) port (may be included as one port in the ports of the I/O interface), a network interface, a power source and/or a camera. A person skilled in the art can understand that the structure shown in FIG. 15 is only an illustration, which is not to define the structure of the above-mentioned electronic device. For example, the computer device 15 may also comprise components that are more or less than those shown in FIG. 15, or have a configuration different from that shown in FIG. 15.

It is to be noticed that the above-mentioned one or more processors 152 and/or other data processing circuits are usually called “the data processing circuit” herein. The data processing circuit may be entirely or partially embodied as software, hardware, firmware or any other combination. In addition, the data processing circuit may be a single independent processing module, or be entirely or partially integrated into any of the other elements in the computer device 15. As referenced in the embodiment of the present application, the data processing circuit is used as a processor control (for example, the selection of routes for the variable resistance terminal that is connected to the interface).

The processor 152 may, through the transmission device, call the information and the application program stored in the storage device so as to implement the following steps: receiving the flow characteristic information reported by the firewall; analyzing the flow characteristic information and/or the network behavior information determined by the flow characteristic information to obtain the analysis result; and on the basis of the analysis result, determining the control instruction to be sent down to the firewall, wherein, the control instruction is used to control the network data passing through the firewall.

The storage device 154 may be used to store the software program and modules for the application software, such as the program instruction/data storage device that correspond to the network data control method in the embodiment of the present application, the processor 152, through running the software program and the modules stored in the storage device 154, implements various functional applications and the data processing, which realizes the network data control method for the application program. The storage device 154 may include a high-speed random access memory and a non-volatile memory, such as one or more magnetic storage device, flash memory, or other non-volatile solid memory. In some examples, the storage device 154 may further include a storage device that is provided remotely relative to the processor 152, and this remote storage device can be connected via a network to the computer device 15. An example of the above network includes but not is limited to the Internet, and enterprise intranet, a local area network, a mobile communication network and the combination thereof.

The transmission device 156 is used to receive or send data via a network. A specific example of the above network may include the wireless network provided by a communication provider for the computer device 15. In an example, the transmission device 156 comprises a network adapter (Network Interface Controller, NIC), which can be connected to other network devices via a base station so as to communicate with the Internet. In an example, the transmission device 156 may be a Radio Frequency (RF) module, which is used to communicate with the Internet in a wireless manner.

The display may be, for example, a touchscreen liquid crystal display (LCD), which allows the user to interact with the user interface of the computer device 15.

It is to be noted here that in some optional embodiments, the computer devices 15 as shown in FIG. 15 may include hardware elements (including the circuit), a software element (including the computer codes stored on the computer readable medium), and the combination of a hardware element and a software element. It shall be pointed out that FIG. 15 is only an example of a specific embodiment, and is for the purpose of showing the types of components that can exist in the computer device 15.

It is to be noted here that in some embodiments, the computer devices as shown in the above-mentioned FIG. 15 have a touchscreen display (also called a “touchscreen” or a “touch display”). In some embodiments, the computer devices as shown in the above-mentioned FIG. 15 have a Graphical User Interface (GUI), the user can perform human-computer interaction with the GUI through the finger touch and/or gesture that touch a touch-sensitive surface, wherein the human-computer interaction function here include optionally the following interactions: creating webpages, drawing, text processing, preparing electronic files, games, video conference, real-time communication, receiving/sending emails, dialogue interface, playing digital video, playing digital music and/or network surfing, and so on, the executable instructions to execute the above-mentioned human computer interaction function are configured/stored in one or more processor executable computer program products or in a readable storage medium.

In the present embodiment, the above-mentioned computer device 15 can implement the program codes for the following steps in the network data control method for the application program: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

Optionally, the above-mentioned processor may also implement the program codes of the following steps: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

Optionally, the above-mentioned processor may also implement the program codes of the following steps: acquiring the network data packet that passes through the firewall, wherein, the network data packet comprises at least one of the following: the inward data packet that flows into the intranet and the outward data packet that flow out of the intranet; inspecting the contents of the network data packet according to the filtering rule of the firewall; filtering the inspection result to obtain the network data packet that has passed the inspection; and extracting the flow characteristic information of the network data packet which have passed the inspection.

Optionally, the above-mentioned flow characteristic information includes at least one of the following: the source network address and the source port information which send the network data packet; the target network address and the target port information which receive the network data packet; the information of the size of the network data packet; the information of the header of the network data packet; the information for the protocol label of the network data packet; the sending time of the network data packet and the receiving time of the network data packet.

Optionally the above-mentioned processor may also implement the program codes for the following steps: in the case of multiple firewalls, receiving the flow characteristic information reported by the multiple firewalls, wherein, the flow characteristic information are those of the network data packet that has passed the inspection of each firewall.

Optionally, the above-mentioned the processor may also implement the program codes for the following steps: performing aggregated analysis on the flow characteristic information reported by the multiple firewalls and/or on the network behavior information determined by the flow characteristic information reported by the multiple firewalls, so as to obtain the aggregated analysis result; and determining the control instructions to be sent down to the multiple firewalls according to the aggregated analysis result.

Optionally, the above-mentioned processor may also implement the program codes for the following steps: determining whether the flow characteristic information of the network data packet that has passed the inspection of each firewall matches the predefined flow characteristics;

In the situation that the flow characteristic information of the network data packet that has passed the inspection of each firewall matches the predefined flow characteristics, a control instruction will be sent down to the corresponding firewall, wherein, the control instruction is used to control the firewall to implement predefined operations that corresponds to the predefined flow characteristics on the network data packet that has passed the firewalls.

Optionally, the above-mentioned processor may also implement the program codes for the following steps: according to the flow characteristic information of the network data packet that has passed the inspection of each firewall, determining the network behavior information of the network data packet that has passed the inspection of each firewall; determining whether the network behavior information of the network data packet that has passed the inspection of each firewall match the predefined network behavior rule; in the situation that the network behavior information of the network data packet that has passed the inspection of each firewall match the predefined network behavior rule, sending the control instruction down to the corresponding firewall, wherein, the control instruction is used to control the firewall to implement the predefined operation corresponding to the predefined network behavior on the network data packet that passes through the firewalls.

Optionally, the above processor may also implement the program codes of the following steps: determining whether the flow characteristic information of the network data packet that has passed the inspection of each firewall matches the predefined flow characteristic; and in the situation that the flow characteristic information of the network data packet that has passed the inspection of each firewall matches the predefined flow characteristics, controlling each firewall to implement a predefined operation that corresponds to the predefined flow characteristics on the network data packet that passes through the firewall.

Optionally, the above-mentioned processor may also implement the program codes of the following steps: according to the flow characteristic information of the network data packet that has passed the inspection of each firewall, determining the network behavior information of the network data packet that has passed the inspection of each firewall; determining whether the network behavior information of the network data packet that has passed the inspection of the firewall match the predefined network behavior rule; and in the situation that the network behavior information match the predefined network behavior rule, controlling each firewall to implement the predefined operation that corresponds to the predefined network behavior rule on the network data packet that passes through the firewall.

Optionally, the above-mentioned predefined flow characteristics include at least one of the following: the frequency for receiving/sending network data packet, the size of the network data packet, the header information load limit for the network data packet, and the degree of matching of the content of the network data packet.

Optionally, the above-mentioned predefined network behavior rule is used to define at least one of the following information: the frequency for receiving/sending network data packet, the size of the network data packet, the similarity of the header information for the network data packet, and the degree of matching of the content of the network data packet.

Optionally, the above-mentioned predefined operations include but are not limited to at least one of the following: forwarding network data packets, discarding network data packets, and blocking network data packets.

Optionally, the above-mentioned processor may also implement the program codes of the following steps: if the network data packet is an inward data packet, then controlling the corresponding firewall, on the basis of the pre-configured target network address and the port information, to forward the inward data packet to the intranet; if the network data packet is the outward data packet, then controlling the corresponding firewall to forward the outward data packet out according to the source network address and the source port information included in the network data packet that has been received by the intranet.

Optionally, the above-mentioned processor may also implement the program codes of the following steps: in the situation of controlling the firewall to block the network data packet being sent to the target network address or the target port information, to control the firewall to block the network data packet coming from the target network address or the target port information; and in the situation of controlling the firewall to block the network data packet that comes from the source network address or the source port information, to control the firewall to block the network data packet to be sent to the source network address or the source port information.

A person skilled in the art can understand that the structure shown in FIG. 15 is only for illustration, and the computer device may also be terminal devices such as a smartphone (such as an android cell phone, an iOS cell phone etc.), a tablet computer, a PDA, a Mobile Internet Device (MID), a PAD and so on. FIG. 15 is not to define the structure of the above-mentioned electronic device. For example, the computer device 15 may also comprise components (such as a network interface, and a display device etc.) that are more or less than those shown in FIG. 15, or have a configuration different from that shown in FIG. 15.

A person skilled in the art can understand that the pair or part of the steps in older methods of the above-mentioned embodiment can be fulfilled by instructing, through programs, the hardware related to the terminal device, wherein the program can be stored in a computer readable storage medium which may include: a flash memory, a read-only memory (ROM), a random-access memory (RAM), a disk or CD, etc.

### Embodiment 6

The embodiment of the present application also provides a storage medium. Optionally, in the present embodiment, the above-mentioned storage medium can be used to store the program codes which are implemented by the network data control method provided in the above-mentioned embodiment, wherein, when running the program, the device where the storage medium is located is controlled to implement any of the optional or preferred network data control methods in the embodiments.

Optionally in the present embodiment, the above-mentioned storage medium may be located in any mobile terminal in the mobile terminal group in the computer network, or located in any mobile terminal of the mobile terminal group.

Optionally, in the present embodiment, the storage medium can be configured to store the program codes for implementing the following steps: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

Optionally, in the present in embodiment, the storage medium is configured to store the program codes for implementing the following steps: acquiring the network data packet that passes through the firewall, wherein, the network data packet comprises at least one of the following: the inward data packet that flows into the intranet and the outward data packet that flow out of the intranet; inspecting the contents of the network data packet according to the filtering rule of the firewall; filtering the inspection result to obtain the network data packet that has passed the inspection; and extracting the flow characteristic information of the network data packet which have passed the inspection.

Optionally, the above-mentioned flow characteristic information includes at least one of the following: the source network address and the source port information which send the network data packet; the target network address and the target port information which receive the network data packet; the information of the size of the network data packet; the information of the header of the network data packet; the information for the protocol label of the network data packet; the sending time of the network data packet and the receiving time of the network data packet.

Optionally, in the present embodiment, the storage medium is configured to store the program codes for implementing the following steps: in the case of multiple firewalls, receiving the flow characteristic information reported by the multiple firewalls, wherein, the flow characteristic information are those of the network data packet that has passed the inspection of each firewall.

Optionally, in the present embodiment, the storage medium is configured to store the program codes for implementing the following steps: performing aggregated analysis on the flow characteristic information reported by the multiple firewalls and/or on the network behavior information determined by the flow characteristic information reported by the multiple firewalls, so as to obtain the aggregated analysis result; and determining the control instructions to be sent down to the multiple firewalls according to the aggregated analysis result.

Optionally, in the present embodiment, the storage medium is configured to store the program codes for implementing the following steps: determining whether the flow characteristic information of the network data packet that has passed the inspection of each firewall matches the predefined flow characteristic; in the situation that the flow characteristic information of the network data packet that has passed the inspection of each firewall matches the predefined flow characteristics, sending a control instruction down to the corresponding firewall, wherein, the control instruction is used to control the firewall to implement predefined operations that corresponds to the predefined flow characteristics on the network data packet that has passed the firewalls.

Optionally, in the present embodiment, the storage medium is configured to store the program codes for implementing the following steps: according to the flow characteristic information of the network data packet that has passed the inspection of each firewall, determining the network behavior information of the network data packet that has passed the inspection of each firewall; determining whether the network behavior information of the network data packet that has passed the inspection of each firewall match the predefined network behavior rule; in the situation that the network behavior information of the network data packet that has passed the inspection of each firewall match the predefined network behavior rule, sending the control instruction down to the corresponding firewall, wherein, the control instruction is used to control the firewall to implement the predefined operation corresponding to the predefined network behavior on the network data packet that passes through the firewalls.

Optionally, in the present embodiment, the storage medium is configured to store the program codes for implementing the following steps: determining whether the flow characteristic information of the network data packet that has passed the inspection of each firewall matches the predefined flow characteristic; and in the situation that the flow characteristic information of the network data packet that has passed the inspection of each firewall matches the predefined flow characteristics, controlling each firewall to implement a predefined operation that corresponds to the predefined flow characteristics on the network data packet that passes through the firewall.

Optionally, in the present embodiment, the storage medium is configured to store the program codes for implementing the following steps: according to the flow characteristic information of the network data packet that has passed the inspection of each firewall, determining the network behavior information of the network data packet that has passed the inspection of each firewall; determining whether the network behavior information of the network data packet that has passed the inspection of the firewall match the predefined network behavior rule; and in the situation that the network behavior information match the predefined network behavior rule, controlling each firewall to implement the predefined operation that corresponds to the predefined network behavior rule on the network data packet that passes through the firewall.

Optionally, the above-mentioned predefined flow characteristics include at least one of the following: the frequency for receiving/sending network data packet, the size of the network data packet, the header information load limit for the network data packet, and the degree of matching of the content of the network data packet.

Optionally, the above-mentioned predefined network behavior rule is used to define at least one of the following information: the frequency for receiving/sending network data packet, the size of the network data packet, the similarity of the header information for the network data packet, and the degree of matching of the content of the network data packet.

Optionally, the above-mentioned predefined operations include but are not limited to at least one of the following: forwarding network data packets, discarding network data packets, and blocking network data packets.

Optionally, in the present embodiment, the storage medium is configured to store the program codes for implementing the following steps: if the network data packet is an inward data packet, then controlling the corresponding firewall, on the basis of the pre-configured target network address and the port information, to forward the inward data packet to the intranet; if the network data packet is the outward data packet, then controlling the corresponding firewall to forward the outward data packet out according to the source network address and the source port information included in the network data packet that has been received by the intranet.

Optionally, in the present embodiment, the storage medium is configured to store the program codes for implementing the following steps: in the situation of controlling the firewall to block the network data packet being sent to the target network address or the target port information, to control the firewall to block the network data packet coming from the target network address or the target port information; and in the situation of controlling the firewall to block the network data packet that comes from the source network address or the source port information, to control the firewall to block the network data packet to be sent to the source network address or the source port information.

### Embodiment 7

The embodiment of the present application also provides a system to determine an object entity, comprising: a processor; and a storage device, connected to the processor, to provide the processor with instruction to process the following processing steps: receiving the flow characteristic information reported by the firewall; analyzing the flow characteristic information and/or the network behavior information determined by the flow characteristic information to obtain the analysis result; on the basis of the analysis result, determining the control instruction to be sent down to the firewall, wherein, the control instruction is used to control the network data passing through the firewall.

Hence, in the solution disclosed in the above-mentioned Embodiment 7 of the present application, by receiving the flow characteristic information reported by each firewall and by performing analysis on the flow characteristic information reported by each firewall to obtain the analysis result, the control instruction can be determined, according to the analysis result, to be sent down to each firewall for controlling the network data passing through the firewall.

It is easily noticeable that the above-mentioned firewall can be one or more, in the case that there are multiple firewalls, the multiple firewalls can be deployed in a distributed manner to meet the objective that to limit network data by distributing which in multiple firewalls to overcome the bandwidth limitation and to perform comprehensive analysis on the network data to overcome network attack, thus realizing the technical effect of improving the network protection performance.

Hence, the solution of the above-mentioned Embodiment 7 provided in the present application has solved the technical problem in the existing firewall modes in terms of their poor performance in protecting network data.

### Embodiment 8

According to the embodiment of the present application, also provided is an embodiment for a data processing method, this embodiment can be applied in the network data control system in Embodiment 1, including but not limited to the scenario in Embodiment 1. It is to be noted that the steps as shown in the flowchart of the drawings can be implemented in a computer system, such as a group of computer implementable instructions, and although a logic sequence is shown in the flowchart, in some situations, the steps shown or described may be implemented in an order different from the one herein.

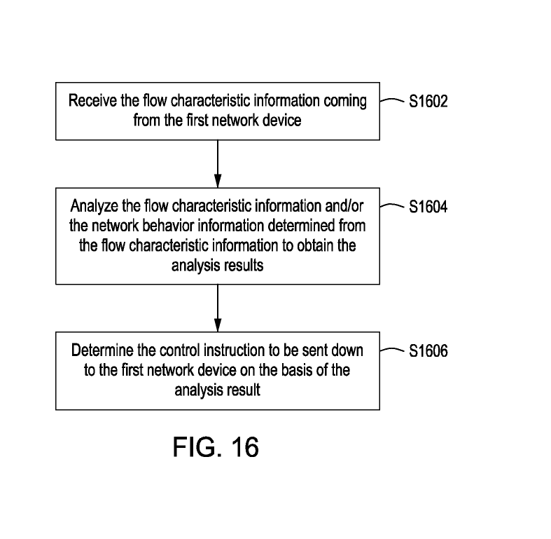

The present invention also provides an embodiment for a data processing method. FIG. 16 is a flowchart, based on the embodiment of the present invention, of a data processing method; as shown in FIG. 16, it comprises the following steps:

Step S1602, receiving the flow characteristic information coming from the first network device.

Specifically, the above-mentioned the first network device may be but is not limited to a firewall. The above-mentioned firewall may be but is not limited to the firewall for network security protection between an intranet and an extranet, between a private network and a public network, and between a user terminal (any device that is accessible to a network, including but not limited to a cell phone, a laptop computer, a computer, and a tablet etc.) and the network it connects with. Optionally, the above-mentioned firewall may be one or more, when there are multiple firewalls, the above-mentioned flow characteristic information may be the flow characteristic information reported by the multiple firewalls.

Optionally, the above-mentioned flow characteristic information includes but is not limited to at least one of the following: the source network address and the source port information which send the network data packet; the target network address and the target port information which receive the network data packet; the information of the size of the network data packet; the information of the header of the network data packet; the information for the protocol label of the network data packet; the sending time of the network data packet and the receiving time of the network data packet.

Step S1604, analyze the flow characteristic information and/or the network behavior information determined from the flow characteristic information to obtain the analysis results.

Specifically, through step S1602, after receiving the flow characteristic information of the network data that pass through and are reported by each firewall, the flow characteristic information of all the firewalls and/or the network behavior information determined from the flow characteristic information can be analyzed comprehensively through the above-mentioned step S1604 to obtain the corresponding analysis results. Optionally, it may only perform analysis on the flow characteristic information reported by the firewall, or determine the corresponding network behavior information on the basis of the flow characteristic information reported by the firewall and perform analysis on the network behavior information, or perform comprehensive analysis on the flow characteristic information and the network behavior information. Further, in the case that there are multiple firewalls, it can perform an aggregated analysis on the flow characteristic information of the multiple firewalls and/or the corresponding network behavior information, so as to determine the control instruction to be sent down on the basis of the result from the aggregated analysis.

Step S1606, determining the control instruction to be sent down to the first network device on the basis of the analysis result, wherein, the control instruction is used to control the network data passing through the first network device.

Specifically, because each firewall can only know the network data passing through itself, this indicates that the network data of a certain IP are distributed to multiple firewalls for protection, there are security risks when depending only on each firewall to protect their respective network data. While only by receiving the flow characteristic information reported by each firewall through the above-mentioned step S1602, according to the step S1604, performing comprehensive analysis on the flow characteristic information for each firewall, and determining the control instruction to be sent down to each firewall through the above-mentioned step S1606 and on the basis of the analysis result obtained in step S1604, that the firework can be accurately controlled to implement corresponding operations.

For example, when the rule of firewall filtering is such that a data packet can smoothly pass a firewall if the number of data packets coming from the same IP address is not greater than N, however, if the data packets of a certain IP address are to be protected through three firewalls, and if the number of the network data packets detected by each firewall is 0.5N, then the network data packets of the IP address will smoothly pass through each firewall. However, actually, if the network data packets for the three firewalls are analyzed together, it can be determined that the number of the network data packets from the IP address is 1.5N, which has exceeded the predefined number N; hence, the firewalls shall be controlled to block or discard the network data packets from the IP address.

It is to be noted that the above-mentioned control instruction is used to control the firewall to implement predefined operations including but not limited to at least one of the following: forwarding network data packets, discarding network data packets, and blocking network data packets. That is, the network data packets that have passed the firewall flow rule can be forwarded out by the firewall, while the network data packets that have failed to pass the firewall flow rule will be discarded or blocked by the firewall.

Hence, in the solution disclosed in the above-mentioned Embodiment 8 of the present invention, through receiving the flow characteristic information from the first network device, analyzing the flow characteristic information and/or the network behavior information determined by the flow characteristic information, thus the analysis result is obtained; and on the basis of the analysis result, the control instruction sent to the first network device is determined, wherein, the control instruction is used to control the network data passing through the first network device.

It is easily noticeable that the above-mentioned firewall can be one or more, in the case that there are multiple firewalls, the multiple firewalls can be deployed in a distributed manner to meet the objective that to limit network data by distributing which in multiple firewalls to overcome the bandwidth limitation and to perform comprehensive analysis on the network data to overcome network attack, thus realizing the technical effect of improving the network protection performance.

Hence, the solution of the above-mentioned Embodiment 8 provided in the present invention has solved the technical problem in the existing firewall modes in terms of their poor performance in protecting network data.

The order number of the embodiments in the present invention is only for the purpose of description, not representing the superiority or inferiority of an embodiment.

In the above-mentioned embodiments of the present invention, each embodiment is described with a focus, and the part not described in detail in a certain embodiment can refer to the relevant descriptions in other embodiments.

In the several embodiments provided in the present invention, it shall be understood that the technical contents disclosed can be realized in other means. Wherein, the embodiment for the device described in the above is only illustrative, for example, the categories of the units are only categorized based on logic functions, and can be categorized in other ways in an actual implementation, for example, multiple units or components can be combined or grouped to another system, or some characteristics may be ignored or not implemented. Moreover, the coupling, direct coupling or communication connection between each other, which are shown or discussed, can be an indirect coupling or communication connection through some interfaces, units or modules, and can be in an electrical manner or otherwise.

The units described as separated components may or may not be separated physically, and the component for unit display may or may not be a physical unit, that is, it can be located in one location or be distributed in multiple network units. Depending on the actual needs, a part of or the entire units thereof can be selected to realize the objective of the solution of the present embodiment.

In addition, although functional units in each embodiment of the present invention can be grouped into one processing unit, or can be individual physical existence in each unit, or two or more units may be grouped into one unit. The integrated unit may be realized in the form of a hardware, or in the form of a software functional unit.

The integrated unit, if being realized in the form of a software functional unit and is sold or used as an independent product, can be stored in a computer readable storage medium. Based on such understanding, the essence of the technical solution of the present invention or the part thereof that has contribution to prior arts, or the entirety or part of the technical solution, can be embodied in the form of software products, wherein the computer software products are stored in the storage medium, and include several instructions used to allow a computer device (probably a personal computer, a server, or a network device etc.) to implement the entirety or part of the steps of the methods described in the embodiments of the present invention. And the previously mentioned storage medium comprises various media that can store program codes, including: a USB flash disk, a read-only memory (ROM), a random-access memory (RAM), a mobile hard drive, a disk or CD and so on.

Described above are only the preferred embodiments of the present invention, it shall be pointed out that for a person skilled in the art, provided that the principle of the present invention is not deviated from, multiple improvements and modification maybe carried out and such improvements and modifications shall also be deemed as within the protection scope of the present application.

What is claimed is:

1. A network data control system comprising:
a firewall located between a first device and a second device to extract flow characteristic information of network data communicated between said first device and said second device; and
a firewall analysis device that communicates with said firewall for
receiving said flow characteristic information reported by said firewall;
analyzing the flow characteristic information or network behavior information determined by said flow characteristic information to obtain an analysis result; and
on the basis of said analysis result determining control instruction to be sent to said firewall,
wherein said control instruction is used to control network data passing through said firewall.

2. The system of claim 1, wherein said firewall comprises:
multiple firewalls deployed in a distributed manner and communicating respectively with the firewall analysis device;
a router connected between each said multiple firewall and said second device for transferring network data between said second device and said each multiple firewall; and
an exchanger connected between each multiple firewall and said first device for transferring network data between each said multiple firewall and said first device.

3. The system of claim 2, wherein said firewall analysis device comprises:
a flow information receiving module to receive the flow characteristic information reported by at least one firewall;
a first flow characteristic computation and decision module connected with said flow information receiving module, for analyzing flow characteristic information reported by said at least one multiple firewall to obtain said analysis result and, on the basis of said analysis result, determining the control instruction to be sent to each firewall; and
a flow-information-decision-sending module connected with said first flow characteristic computation and decision module for sending said control instruction to the corresponding firewall.

4. The system of claim 3, wherein said firewall comprises:
a flow-filtering-engine module used in the case of acquiring a network data packet passing through said each multiple firewall and, on the basis of a filtering rule of said each multiple firewall, to inspect the contents of said network data packet and to filter the inspection result to obtain a network data packet that has passed the inspection; and
a flow-characteristic-extracting module, connected with said flow-filtering-engine module for extracting said flow characteristic information of the network data packet that has passed the inspection.

5. The system of claim 4, wherein said multiple firewall also comprises:
a second flow characteristic computation and decision module, connected with said flow-characteristic-extracting module for determining, on the basis of flow characteristic information of network data packet obtained through filtering by said flow-filtering-engine module, the pre-defined operation to be implemented by said each said multiple firewall on the network data packet that passes through said firewall; and
a flow-information-receiving/sending module, connected respectively with said second flow characteristic computation and decision module and the flow information receiving module of said firewall analysis device for sending the flow characteristic information of network data packet that has passed said firewall based on the decision of said second flow characteristic computation and decision module, to the flow information receiving module in said firewall analysis device.

6. The system of claim 5, wherein each said multiple firewall also comprises:
a forwarding-back-to-source module connected with said first flow characteristic computation and decision module, for forwarding network data packet that is decided, by said first flow characteristic computation and decision module, to pass said each multiple firewall; and
a flow-information-forwarding-management module, connected to said forwarding-back-to-source module, for providing to said forwarding-back-to-source module, a target network address and a target port information of the network data packet that passes through the firewall.

7. A network data control method comprising:
receiving flow characteristic information reported by a firewall;
analyzing said flow characteristic information and/or the network behavior information determined from said flow characteristic information to obtain an analysis results; and
determining control instruction to be sent to said firewall on the basis of the analysis result, wherein the control instruction is used to control network data passing through said firewall.

8. The method of claim 7, wherein before receiving the flow characteristic information reported by the firewall, said method comprising:
acquiring the network data packet that passes through said firewall, wherein said network data packet comprises at least one of the following: an inward data packet that flows into the intranet and an outward data packet that flows outside the intranet;
inspecting the contents of said network data packet according to a filtering rule of said firewall;
filtering the inspection result, to obtain the network data packet that has passed the inspection; and
extracting said flow characteristic information of a network data packet that has passed inspection.

9. The method of claim 8, wherein said flow characteristic information includes at least one of the following: a source network address and a source port information which send the network data packet; a target network address and a target port information which receive the network data packet; information on the size of the network data packet; information on the header of the network data packet; information for a protocol label of the network data packet; the sending-time of the network data packet and the receiving-time of the network data packet.

10. The method of claim 9, wherein in the case of multiple said firewalls, receiving the flow characteristic information reported by multiple said firewalls, wherein said flow characteristic information is that of network data packet that has passed inspection by each firewall.

11. The method of claim 10, wherein said flow characteristic information and/or network behavior information determined by said flow characteristic information are analyzed to obtain an analysis result and, according to said analysis result, control instructions to be sent to said firewall are determined, including:
performing aggregated analysis on the flow characteristic information reported by said multiple firewalls and/or network behavior information determined by the flow characteristic information reported by said multiple firewalls to obtain an aggregated analysis result; and
according to said aggregated analysis result, determining control instruction to be sent to said multiple firewalls.

12. The method of claim 11, wherein according to said aggregated analysis result, control instructions to be sent to said multiple firewalls are determined, including:
determining whether the flow characteristic information of the network data packet that has passed inspection by each said firewall matches the predefined flow characteristics; and
in the situation that the flow characteristic information of the network data packet that has passed inspection of each said firewall matches the predefined flow characteristics, said control instruction will be sent to the corresponding firewall, wherein said control instruction is used to control said firewall to implement predefined operations that correspond to said predefined flow characteristics on the network data packet that has passed said firewall.

13. The method of claim 12, wherein according to said aggregated analysis result, the control instructions to be sent to said multiple firewalls are determined, including:
according to the flow characteristic information of the network data packet that has passed inspection by each said firewall, determining the network behavior information of the network data packet that has passed inspection by each said firewall;
determining whether the network behavior information of the network data packet that has passed inspection by each said firewall matches the predefined network behavior rule; and
in the situation that the network behavior information of the network data packet that has passed inspection by each said firewall matches the predefined network behavior rule, sending said control instruction to the corresponding firewall, wherein said control instruction is used to control said firewall to implement the predefined operation that corresponds to said predefined network behavior on the network data packet that passes through said firewall.

14. The method of claim 10, wherein before receiving the flow characteristic information reported by said multiple firewalls, said method comprising:
determining whether the flow characteristic information of the network data packet that has passed inspection by each said firewall matches the predefined flow characteristics; and
in the situation that the flow characteristic information of the network data packet that has passed inspection of each said firewall matches the predefined flow characteristics, controlling said firewall to implement predefined operations that corresponds to said predefined flow characteristics on the network data packet that has passed said firewall.

15. The method of claim 10, wherein before receiving flow characteristic information reported by said multiple firewalls, said method comprising:
according to the flow characteristic information of the network data packet that has passed the inspection by each said firewall, determining the network behavior information of the network data packet that has passed inspection by each said firewall;
determining whether the network behavior information of the network data packet that has passed inspection by each said firewall matches the predefined network behavior rule; and
in the situation that said network behavior information matches said predefined network behavior rule, controlling each said firewall to implement the predefined operation that corresponds to said predefined network behavior on the network data packet that passes through said firewall.

16. The method of claim 12, wherein said predefined flow characteristics include at least one of the following: the frequency for receiving/sending network data packet, the size of the network data packet, the header information load limit for the network data packet, and the degree of matching of the content of the network data packet.

17. The method of claim 13, wherein said predefined network behavior rule is used to define at least one of the following information: the frequency for receiving/sending network data packet, the size of the network data packet, the similarity of the header information for the network data packet, and the degree of matching of the content of the network data packet.

18. The method of any of claim 12, wherein said predefined operations include at least one of the following: forwarding network data packets, discarding network data packets, and blocking network data packets.

19. The method of claim 18, wherein said predefined operation is to forward the network data packet, said method also including:
if said network data packet is an inward data packet, then controlling the corresponding firewall to forward said inward data packet to said intranet according to the a pre-configured target network address and the port information; and
if said network data packet is an outward data packet, then controlling the corresponding firewall to forward said outward data packet out according to the source network address and the source port information included in the network data packet that has been received by said intranet.

20. The method of claim 19, wherein when said predefined operation is to block the network data packet, said method including:
in the case of controlling said firewall to block the network data packet being sent to the target network address or to the target port information, controlling said firewall to block the network data packet coming from said target network address or said target port information; and
in the case of controlling said firewall to block the network data packet sent from the source network address or to the source port information, controlling said firewall to block the network data packet to be sent to the source network address or the source port information.
